(19) United States
(12) Patent Application Publication
(10) Pub. No.: US 2025/0162692 A1
(43) Pub. Date: May 22, 2025

(54) LinQ ski pylon modification to provide a seat post and swivel seat for Sea Doo personal watercraft

(71) Applicant: Daniel Harrison Dudley, Bullhead City, AZ (US)

(72) Inventor: Daniel Harrison Dudley, Bullhead City, AZ (US)

(21) Appl. No.: 18/212,510

(22) Filed: Nov. 22, 2023

(51) Int. Cl. B63B 29/04; B60N 2/14; B63B 34/10

(52) U.S. Cl. CPC B63B 29/04; B60N 2/14; B63B 34/10; B63B 2029/043

(57) ABSTRACT

Modifying a Sea Doo LinQ ski pylon to provide a seat post and swivel seat

### DESCRIPTION OF THE DRAWING ITEMS

FIG. 1 is an illustration of the original Sea Doo watercraft (PWC) LinQ retractable ski pylon accessory with spotter grab handle

FIG. 2 shows this LinQ ski pylon having been adapted and modified by removing the spotter grab handle and attaching a seat pedestal and swivel by any means, not limited to welding or other types of mechanical fasteners.

### BRIEF DESCRIPTION OF THE INVENTION

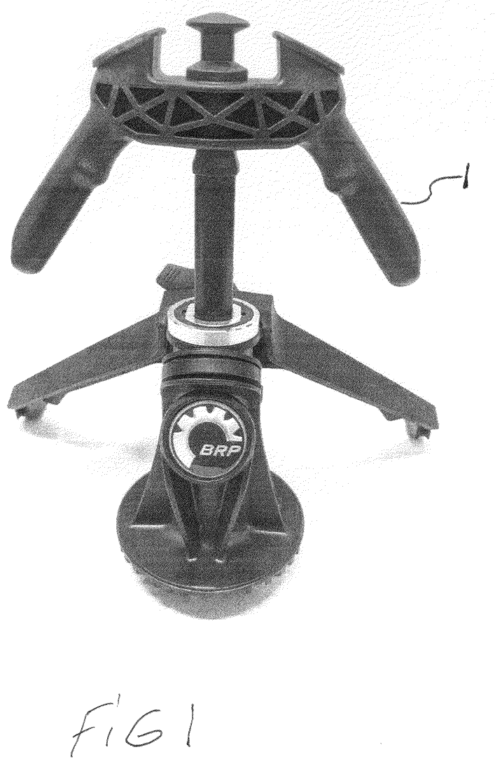

In reference to FIG. 1 this shows the Sea Doo personal watercraft (PWC) accessory of a LinQ Retractable Ski Pylon with spotter grab handle that fits on the majority of Sea Doo personal watercraft with the LinQ attachment accessory system.

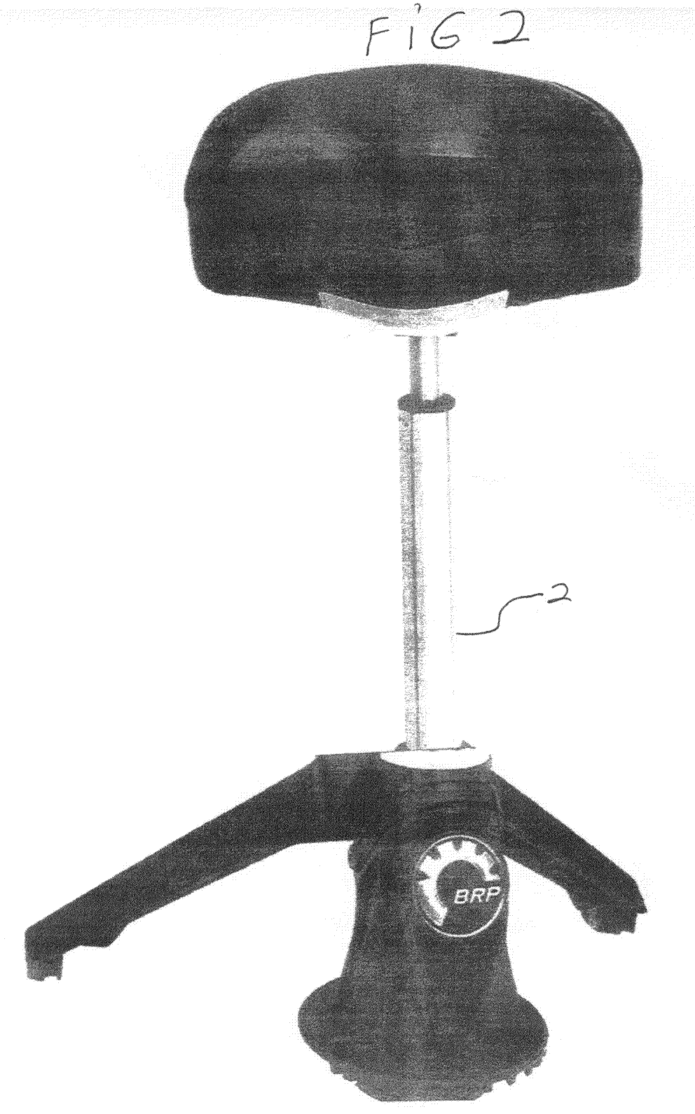

In reference to FIG. 2 this shows this LinQ Ski Pylon having been adapted and modified by removing the spotter grab handle and attaching a seat pedestal and swivel allowing the users of these Sea Doo personal watercraft the use of a swiveling seat.

1. This invention will adapt and modify the Sea Doo LinQ ski pylon to provide a seat pedestal and swivel seat to allow users to pivot and spin on this seat while on the watercraft.
